(19) United States
(12) Patent Application Publication
(10) Pub. No.: US 2025/0086951 A1
(43) Pub. Date: Mar. 13, 2025

(54) OBJECT TRACKING APPARATUS AND METHOD

(71) Applicants: HYUNDAI MOTOR COMPANY, Seoul (KR); KIA CORPORATION, Seoul (KR); KOOKMIN UNIVERSITY INDUSTRY ACADEMY COOPERATION FOUNDATION, Seoul (KR)

(72) Inventors: Se Jong Heo, Anyang-si (KR); Yeon Sik Kang, Seoul (KR); Kyung Jae Ahn, Seongnam-si (KR); Jin Hyun Lee, Seoul (KR); Yun Jung Kim, Siheung-si (KR); Ha Rin Jang, Seoul (KR)

(73) Assignees: HYUNDAI MOTOR COMPANY, Seoul (KR); KIA CORPORATION, Seoul (KR); KOOKMIN UNIVERSITY INDUSTRY ACADEMY COOPERATION FOUNDATION, Seoul (KR)

(21) Appl. No.: 18/677,594

(22) Filed: May 29, 2024

(30) Foreign Application Priority Data
Sep. 11, 2023 (KR) 10-2023-0120567

(51) Int. Cl. G06V 10/80; G06T 7/246; G06V 10/25; G06V 10/762; G06V 10/764; G06V 20/58

(52) U.S. Cl. CPC G06V 10/803; G06T 7/246; G06V 10/25; G06V 10/762; G06V 10/764; G06V 20/58; G06T 2207/10028; G06T 2207/30252

(57) ABSTRACT

An object tracking apparatus and method are provided. The object tracking apparatus includes a sensor device that obtains surrounding information of a vehicle and a processor that tracks an object outside the vehicle based on the surrounding information obtained by the sensor device. The processor generates a grid map based on the surrounding information, deep-learns the grid map to obtain a classification object, detects an occupancy grid from the grid map and obtains a grid object based on clustering the occupancy grid, and fuses the classification object with the grid object to track the object.

### CROSS-REFERENCE TO RELATED APPLICATION

This application claims the benefit of and priority to Korean Patent Application No. 10-2023-0120567, filed in the Korean Intellectual Property Office on Sep. 11, 2023, the entire contents of which are incorporated herein by reference.

### TECHNICAL FIELD

The present disclosure relates to an object tracking apparatus and a method thereof, and more particularly to technologies of detecting an object outside a vehicle and tracking the detected object.

### BACKGROUND

An autonomous vehicle refers to a vehicle capable of operating on its own without the manipulation of its driver or passenger. Autonomous driving systems refer to systems that monitor and control the autonomous vehicle to operate on its own. The autonomous vehicle may refer to a vehicle that monitors the outside of the vehicle for driving assistance of the driver and that is equipped with various driving assistance means based on the monitored environments outside the vehicle.

The autonomous vehicle or a vehicle equipped with a driving assistance device monitors the outside of the vehicle to detect an object and controls the vehicle based on a scenario determined according to the detected object. In other words, autonomous driving or driving according to the driving assistance device is generally premised on the process of determining a type of object outside the vehicle.

A scheme that deep-learns pieces of information obtained by sensors is generally used to recognize an object outside the vehicle, but there are still limitations in object detection performance. Thus, there is a need for a technology capable of enhancing object recognition performance.

### SUMMARY

The present disclosure has been made to solve the above-mentioned problems occurring in the prior art while advantages achieved by the prior art are maintained intact.

Aspects of the present disclosure provide an object tracking apparatus and a method for recognizing even an object that is not detected by deep learning.

Other aspects of the present disclosure provide an object tracking apparatus and a method for enhancing object recognition performance, while accurately identifying a shape or a class of the object.

Still other aspects of the present disclosure provide an object tracking apparatus and a method for more accurately tracking an object.

The technical problems to be solved by the present disclosure are not limited to the aforementioned problems. Any other technical problems not mentioned herein should be more clearly understood from the following description by those of ordinary skill in the art to which the present disclosure pertains.

According to an aspect of the present disclosure, an object tracking apparatus may include a sensor device that obtains surrounding information of a vehicle and a processor that tracks an object outside the vehicle based on the surrounding information obtained by the sensor device. The processor may generate a grid map based on the surrounding information, may deep-learn the grid map to obtain a classification object, may detect an occupancy grid from the grid map and may obtain a grid object based on clustering the occupancy grid, and may fuse the classification object with the grid object to track the object.

According to an embodiment, the processor may generate the grid map in the form of a top-view image.

According to an embodiment, the processor may set a region of interest for limiting an object tracking region on the grid map.

According to an embodiment, the processor may obtain a bounding box surrounding the classification object, a class matched with the bounding box, and speed information of the classification object.

According to an embodiment, the processor may extract the occupancy grid based on an occupancy probability that the object will be present on each grid of the grid map, may extract one or more surrounding grids adjacent to the occupancy grid, and may obtain the grid object including the occupancy grid and the surrounding grids.

According to an embodiment, the processor may divide the grid object into two or more different grid objects based on a speed of each grid that belongs to the grid object.

According to an embodiment, the processor may determine a tracking point in the grid object in a first frame, may set an effective range around a prediction point of the tracking point in a moving state, and may determine whether the tracking point measured in a second frame obtained after the first frame is located within the effective range and proceeds with tracking the grid object.

According to an embodiment, the processor may determine a cluster area occupied by the grid object, may determine an overlapping area between an area of the bounding box and the cluster area, and may determine that the classification object and the grid object are the same object based on a size of the overlapping area compared to the cluster area is greater than or equal to a predetermined threshold.

According to an embodiment, the processor may obtain a convex hull surrounding the grid object using a convex hull algorithm and may determine an internal area of the convex hull as the cluster area.

According to an embodiment, the processor may obtain one or more intersection points in which the bounding box and the convex hull intersect each other, may obtain one or more first internal points located in the bounding box among boundary points included in the convex hull, and may obtain one or more second internal points located in the convex hull among grids corresponding to vertices of the bounding box. The processor may also determine an area connecting the intersection point, the first intersection points, and the second intersection points as the overlapping area.

According to an aspect of the present disclosure, an object tracking method may include: generating a grid map based on surrounding information outside a vehicle; deep-learning the grid map to obtain a classification object; detecting an occupancy grid from the grid map and obtaining a grid object based on clustering the occupancy grid; and fusing the classification object with the grid object to track an object.

According to an embodiment, generating the grid map may include generating the grid map in the form of a top-view image.

According to an embodiment, the object tracking method may further include setting a region of interest for limiting an object tracking region.

According to an embodiment, obtaining the classification object may include obtaining a bounding box surrounding the classification object, obtaining a class matched with the bounding box, and obtaining speed information of the classification object.

According to an embodiment, obtaining the grid object may include extracting an occupancy grid based on an occupancy probability that the object will be present on each grid of the grid map, extracting one or more surrounding grids adjacent to the occupancy grid, and obtaining the grid object including the occupancy grid and the surrounding grids.

According to an embodiment, obtaining the grid object may further include dividing the grid object into two or more different grid objects based on a speed of each grid included in the grid object.

According to an embodiment, obtaining the grid object may include determining a tracking point in the grid object in a first frame, setting an effective range around a prediction point of the tracking point in a moving state, and determining whether the tracking point measured in a second frame obtained after the first frame is located within the effective range and proceeding with tracking the grid object.

According to an embodiment, fusing the classification object with the grid object to track the object may include determining a cluster area occupied by the grid object, determining an overlapping area between an area of the bounding box and the cluster area, and determining that the classification object and the grid object are the same object, based on a size of the overlapping area compared to the cluster area is greater than or equal to a predetermined threshold.

According to an embodiment, determining the cluster area may include obtaining a convex hull surrounding the grid object using a convex hull algorithm and determining an internal area of the convex hull as the cluster area.

According to an embodiment, fusing the classification object with the grid object to track the object may include obtaining one or more intersection points in which the bounding box and the convex hull intersect each other, obtaining one or more first internal points located in the bounding box among boundary points included in the convex hull, and obtaining one or more second internal points located in the convex hull among grids corresponding to vertices of the bounding box. Fusing the classification object may also include determining an area connecting the intersection point, the first intersection points, and the second intersection points as the overlapping area.

### BRIEF DESCRIPTION OF THE DRAWINGS

The above and other objects, features, and advantages of the present disclosure should be more apparent from the following detailed description taken in conjunction with the accompanying drawings:

FIG. 1 a block diagram illustrating a configuration of an object tracking apparatus and a configuration of a vehicle control apparatus including the same according to an embodiment of the present disclosure;

FIG. 2 is a drawing illustrating a vehicle loaded with a sensor device of an object tracking apparatus according to an embodiment of the present disclosure;

FIG. 3 is a flowchart for describing an object tracking method according to an embodiment of the present disclosure;

FIG. 4 is a flowchart for describing an object tracking method according to another embodiment of the present disclosure;

FIG. 5 is a drawing illustrating an example of a grid map;

FIG. 6 is a drawing illustrating representing an occupancy probability as a grid map;

FIG. 7 is a drawing illustrating representing a non-occupancy probability as a grid map;

FIG. 8 is a drawing illustrating an example of classification objects obtained using an SSD model;

FIG. 9 is a drawing for describing a method for tracking a classification object;

FIG. 10 is a drawing for describing a method for obtaining a grid object;

FIG. 11 is a drawing for describing a method for tracking a grid object;

FIG. 12 is a drawing illustrating a bounding box area;

FIG. 13 is a drawing illustrating a cluster area;

FIG. 14 is a drawing for describing a method for determining an intersection area between a bounding box area and a cluster area;

FIG. 15 is a drawing for describing an example of an object tracking method according to an embodiment of the present disclosure; and

FIG. 16 is a block diagram illustrating a computing system according to an embodiment of the present disclosure.

### DETAILED DESCRIPTION

Hereinafter, some embodiments of the present disclosure are described in detail with reference to the drawings. In the drawings, the same reference numerals are used throughout to designate the same or equivalent components. In addition, a detailed description of well-known features or functions has been omitted in order not to unnecessarily obscure the gist of the present disclosure.

In describing the components of an embodiment according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this disclosure belongs. It should be understood that terms used herein should be interpreted as having a meaning that is consistent with their meaning in the context of this disclosure and the relevant art and should not be interpreted in an idealized or overly formal sense unless expressly so defined herein. When a component, device, element, or the like of the present disclosure is described as having a purpose or performing an operation, function, or the like, the component, device, or element should be considered herein as being “configured to” meet that purpose or to perform that operation or function.

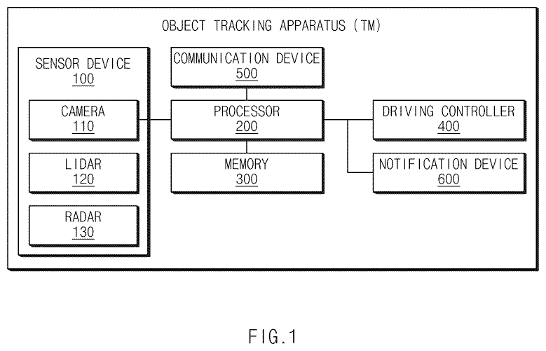

Hereinafter, embodiments of the present disclosure are described in detail with reference to FIGS. 1-16.

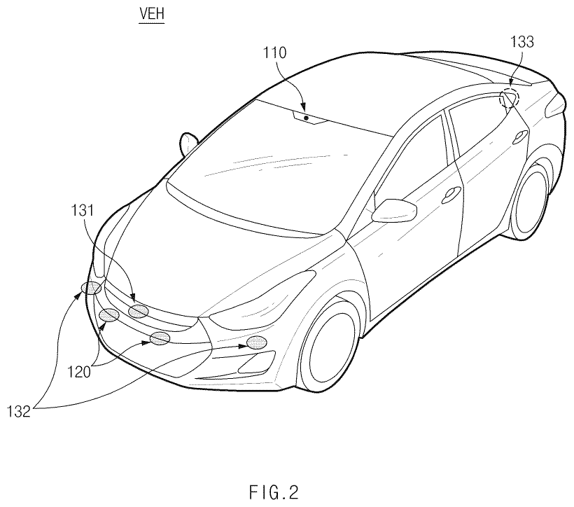

FIG. 1 a block diagram illustrating a configuration of an object tracking apparatus and a configuration of a vehicle control apparatus including the same according to an embodiment of the present disclosure. FIG. 2 is a drawing illustrating a vehicle loaded with a sensor device of the object tracking apparatus according to an embodiment of the present disclosure.

Referring to FIGS. 1 and 2, the object tracking apparatus TM may include a sensor device 100, a processor 200, and a memory 300. The object tracking apparatus TM may further include a driving controller 400, a communication device 500, and a notification device 600, and may be mounted on a vehicle VEH.

The sensor device 100 may include at least one of a camera 110, light imaging detection and ranging (LIDAR) 120, or radio detection and ranging (RADAR) 130, which detect an external object of the vehicle VEH.

The camera 110 may obtain an external image of the vehicle VEH, which may obtain an image in front of the vehicle VEH or an image at a front side of the vehicle VEH. For example, the camera 110 may be disposed around a front windshield to obtain the image in front of the vehicle VEH.

The LIDAR 120 may transmit a laser and may determine an object using a reflected wave of the laser reflected from the object, which may be implemented in a time of flight (TOF) scheme or a phase-shift scheme. The LIDAR 120 may be mounted to be exposed to the outside of the vehicle VEH and may be disposed around a front bumper or a front grill of the vehicle VEH.

The RADAR 130 may include an electromagnetic wave transmission module and an electromagnetic wave reception module. The RADAR 130 may be implemented in a pulse radar scheme or a continuous wave radar scheme according to the principle of radio wave emission. The RADAR 130 may be implemented in a frequency modulated continuous wave (FMCW) scheme or a frequency shift keying (FSK) scheme depending on a signal waveform in the continuous wave radar scheme. The RADAR 130 may include a front RADAR 131 located on a front center of the vehicle VEH, front side RADARs 132 located at both sides of the front bumper, and a rear RADAR 133 located on the rear of the vehicle VEH.

The positions of the camera 110, the LIDAR 120, and the RADAR 130 may not be limited to the embodiment shown in FIG. 2.

Other than those shown in the drawing, the sensor device 100 may include an ultrasonic sensor and/or an infrared sensor. The ultrasonic sensor may include an ultrasonic wave transmission module and an ultrasonic wave reception module. The ultrasonic sensor may detect an object based on an ultrasonic wave and may detect a position of the detected object, a distance from the detected object, and a relative speed to the detected object. The ultrasonic sensor may be disposed on a suitable position outside the vehicle VEH to detect an object located on the front, rear, or side of the vehicle VEH. The infrared sensor may include an infrared ray transmission module and an infrared ray reception module. The infrared sensor may detect an object based on an infrared light and may detect a position of the detected object, a distance from the detected object, and a relative speed to the detected object. The infrared sensor may be disposed on the outside of the vehicle VEH to detect an object located on the front, rear, or side of the vehicle VEH.

Furthermore, the sensor device 100 may further include a brake-pedal position sensor (BPS) for generating a speed control command for gear shift of the vehicle VEH and an accelerator position sensor (APS).

The BPS may output a BPS signal depending on a pressing degree of a brake pedal provided in the vehicle VEH. For example, the BPS signal may be to output data of 0 to 100 depending on the pressing of the brake pedal. A value of 0 may be a value when there is no pressing of the brake pedal. A value of 100 may be a value when the pressing of the brake pedal is a maximum.

The APS may output an APS signal depending on a pressing degree of an accelerator pedal provided in the vehicle VEH. For example, the APS signal may be to output data of 0 to 100 depending on the pressing of the accelerator pedal. A value of 0 may be a value when there is no pressing of the accelerator pedal. A value of 100 may be a value when the pressing of the accelerator pedal is a maximum.

The processor 200 may obtain surrounding information outside the vehicle VEH and may generate a grid map based on the obtained surrounding information. The surrounding information may be pieces of information obtained by the sensor device 100. The grid map may be to represent object information on a grid using the output value of the sensor device 100. The respective grids on the grid map may be divided according to an occupancy probability. Furthermore, the processor 200 may obtain speed information of the respective grids. The grid map may be generated in the form of a top-view image.

The processor 200 may learn the grid map to obtain a classification object. To this end, the processor 200 may include a deep learning network for image learning. The classification object may be output in the form of a bounding box. Furthermore, the processor 200 may obtain classes of the classification objects and may estimate speed information of the classification object.

The processor 200 may detect an occupancy grid from the grid map and may obtain a grid object based on clustering the occupancy grid. The occupancy grid may refer to grids, each of which has an occupancy probability of a certain level or more. The processor 200 may extract surrounding grids adjacent to the occupancy grid and may obtain a grid object including the occupancy grid and the surrounding grids.

The processor 200 may fuse the classification object with the grid object to track an object. According to an embodiment, the processor 200 may determine the classification object and the grid object as the same object based on a size of an overlapping area compared to a cluster area occupied by the grid object being greater than or equal to a predetermined threshold. The overlapping area may refer to an overlapped area between an area of a bounding box and the cluster area.

The processor 200 may include an artificial intelligence (AI) processor to perform at least one of respective procedures for performing object tracking. The AI processor may train a neural network using a previously stored program. The neural network for detecting a target vehicle and a dangerous vehicle may include a plurality of network nodes having weights, which may be designed to simulate a human brain structure on the computer and may simulate neurons of the human neural network. The plurality of network nodes may transmit and receive data depending on each connection relationship to simulate the synaptic activity of neurons which transmit and receive signals through the synapse. The neural network may include a deep learning model developed from a neural network model. The plurality of network nodes in the deep learning model may be located on different layers to transmit and receive data depending on a convolution connection relationship. An example of the deep learning model may include various deep learning techniques such as deep neural networks (DNN), convolutional deep neural networks (CNN), a recurrent neural network (RNN), a restricted Boltzmann machine (RBM), deep belief networks (DBN), and a deep Q-network.

The memory 300 may store an algorithm for an operation of the processor 200 and an AI processor. The memory 300 may use a hard disk drive, a flash memory, an electrically erasable programmable read-only memory (EEPROM), a static random-access memory (SRAM), a ferro-electric RAM (FRAM), a phase-change RAM (PRAM), a magnetic RAM (MRAM), a dynamic RAM (DRAM), a synchronous DRAM (SDRAM), a double date rate-SDRAM (DDR-SDRAM), or the like.

The driving controller 400 may control steering and deceleration and acceleration of the vehicle VEH in response to a control signal from the processor 200, which may include a steering controller, an engine controller, a braking controller, and/or a transmission control module.

The steering controller may be divided into a hydraulic power steering (HPS) system for controlling steering using hydraulic pressure formed by a hydraulic pump and a motor driven power steering system (MDPS) for controlling steering using an output torque of an electric motor.

The engine controller is an actuator for controlling the engine of the vehicle VEH, which controls acceleration of the vehicle VEH. The engine controller may be implemented as an engine management system (EMS). The engine controller controls a driving torque of the engine depending on accelerator pedal position information output from the APS. The engine controller controls engine power for following the driving speed of the vehicle VEH requested from the processor 200 during autonomous driving or during driving according to a driving assistance device.

The braking controller is an actuator for controlling deceleration of the vehicle VEH, which may be implemented as electronic stability control (ESC). The braking controller controls braking pressure for following a target speed requested from the processor 200. In other words, the braking controller controls the deceleration of the vehicle VEH.

The transmission control module is an actuator for controlling the transmission of the vehicle VEH, which may be implemented as shift by wire (SBW). The transmission control module controls a gear shift of the vehicle VEH depending on a gear position and a gear state range.

The communication device 500 may communicate with a user terminal, another vehicle, or an external server and may receive weather information or vehicle information of surrounding vehicles.

The communication device 500 may support short range communication, using at least one of Bluetooth, radio frequency identification (RFID), infrared data association (IrDA), ultra wideband (UWB), ZigBee, near field communication (NFC), wireless-fidelity (Wi-Fi), Wi-Fi Direct, and wireless universal serial bus (USB) technologies.

The communication device 500 may include global positioning system (GPS) module or a differential GPS (DGPS) module for obtaining position information.

Furthermore, the communication device 500 may include a vehicle-to-everything (V2X) communication module. The V2X communication module may include an RF circuit for a wireless communication protocol with a server (vehicle to infrastructure (V2I)), another vehicle (vehicle to vehicle (V2V)), or a pedestrian (vehicle to pedestrian (V2P)). The communication device 500 may receive sensing data obtained by a sensing data of another vehicle through the V2X communication module and may provide the processor 200 with the sensing data.

The notification device 600 may notify a passenger of a vehicle tracking situation and a vehicle avoidance situation by the processor 200. The notification device 600 may include a display, a speaker, or the like.

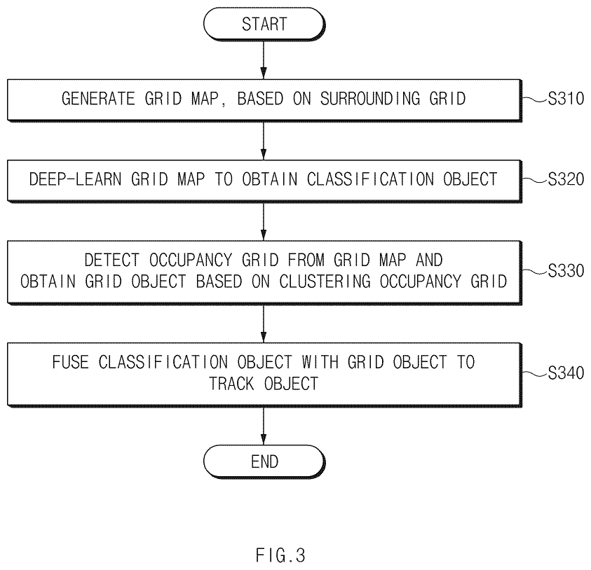

FIG. 3 is a flowchart for describing an object tracking method according to an embodiment of the present disclosure. Procedures shown in FIG. 3 may be performed by a processor 200 shown in FIG. 1. Hereinafter, a description is given of an object tracking method according to an embodiment of the present disclosure with reference to FIGS. 1-3.

In S310, a processor 200 may generate a grid map, based on surrounding information outside a vehicle VEH.

To this end, the processor 200 may receive an output value obtained by a sensor device 100. Alternatively, the processor 200 may receive a high-definition map in an area where the vehicle VEH travels from the outside of the vehicle VEH through a communication device 500.

The processor 200 may generate a grid map in the form of a top-view image, based on the surrounding information outside the vehicle VEH.

In S320, the processor 200 may deep-learn the grid map to obtain a classification object.

To this end, the processor 200 may use a deep learning network for image learning.

The processor 200 may obtain a bounding box surrounding the classification object and a class matched with the bounding box as outputs of the deep learning network. Furthermore, the processor 200 may obtain speed information of the classification object. The speed information of the classification object may use speed prediction information of a dynamic grid map.

In S330, the processor 200 may detect an occupancy grid from the grid map and may obtain a grid object based on clustering the occupancy grid.

The processor 200 may extract an occupancy grid based on an occupancy probability that an object will be present on a grid. Furthermore, the processor 200 may extract one or more surrounding grids adjacent to the occupancy grid. Furthermore, the processor 200 may obtain a grid object including the occupancy grid and the surrounding grid.

In S340, the processor 200 may fuse the classification object with the grid object to track the object.

The processor 200 may determine a cluster area occupied by the grid object. Furthermore, the processor 200 may determine an overlapping area between an area of a bounding box and the cluster area. The processor 200 may determine the classification object and the grid object as the same object based on a size of the overlapping area compared to the cluster area being greater than or equal to a predetermined threshold.

Hereinafter, a description is given of a detailed embodiment tracking method and respective procedures according to another embodiment of the present disclosure.

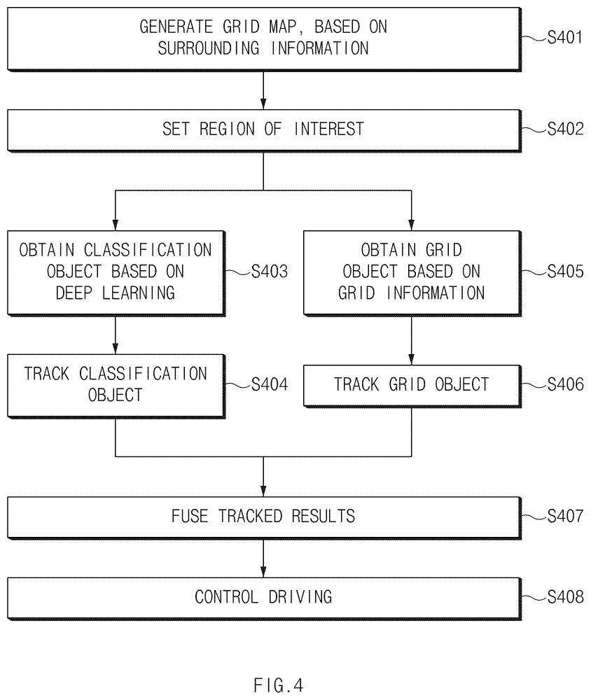

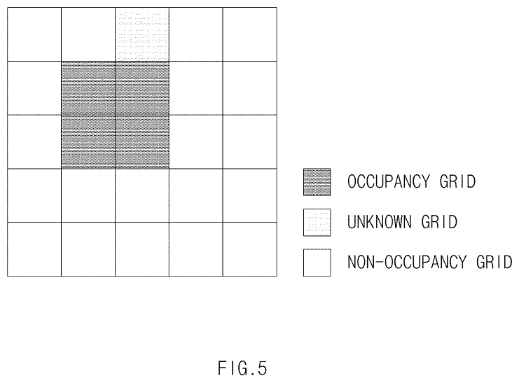

FIG. 4 is a flowchart for describing an object tracking method according to another embodiment of the present disclosure. FIGS. 5-14 are drawings for describing detailed procedures shown in FIG. 4. Procedures shown in FIG. 4 may be performed by a processor 200 shown in FIG. 1. Hereinafter, a description is given of an object tracking method according to another embodiment of the present disclosure with reference to FIGS. 4-14.

In S401, a processor 200 may generate a grid map, based on surrounding information.

The processor 200 may receive the surrounding information. The surrounding information may be sensing data obtained by a camera 110, LIDAR 120, RADAR 130, or the like. Furthermore, the surrounding information may be a high-definition map received through a communication device 500. The processor 200 may generate a grid map, based on the surrounding information.

FIG. 5 is a drawing illustrating an example of a grid map.

Referring to FIG. 5, a processor 200 may represent an output value of a sensor device 100 on an independent grid. The respective grids may be divided according to an occupancy probability of an object. For example, a non-occupancy grid may be a grid in which an occupancy probability is less than a first threshold probability. An occupancy grid may be a grid in which an occupancy probability is greater than or equal to a second threshold probability. An unknown grid may be a grid in which an occupancy probability is greater than or equal to the first threshold probability and is less than the second threshold probability. The second threshold probability may be set to a magnitude greater than the first threshold probability.

Respective grids on the grid map may include independent information, and pieces of information of grids may be updated for each frame.

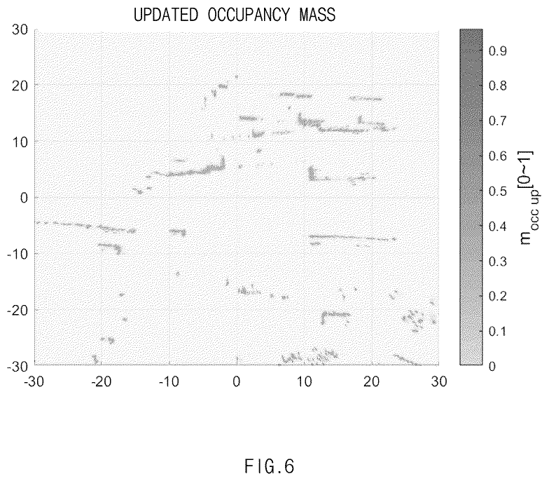

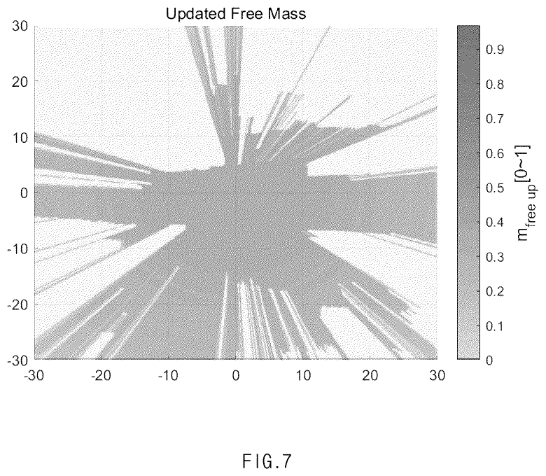

FIGS. 6 and 7 are drawings illustrating an example of a grid map. FIG. 6 is a drawing illustrating representing an occupancy probability as a grid map. FIG. 7 is a drawing illustrating representing a non-occupancy probability as a grid map.

Referring to FIGS. 6 and 7, a processor 200 may represent the occupancy probability or the non-occupancy probability as the grid map. The occupancy probability or the non-occupancy probability may be obtained based on a measurement model of a sensor device 100.

Furthermore, the processor 200 may generate a grid map form representing a grid speed. The grid speed may be the result of a dynamic grid map obtained using a particle filter.

Furthermore, the processor 200 may generate a grid map representing a maximum grid height. The maximum grid height may refer to the highest object height that is present on the grid and may be obtained based on a sensing result of the sensor device 100.

Furthermore, the processor 200 may generate a grid map representing a minimum grid height. The minimum grid height may refer to the lowest object height that is present on the grid and may be obtained based on a sensing result of the sensor device 100.

In S402, the processor 200 may set a region of interest.

The region of interest may be to limit an object tracking region. For example, the region of interest may include a region where a vehicle and a pedestrian are able to appear, for example, a road, an intersection, or a sidewalk, and a region where a facility assisting with operation of a vehicle is able to be installed.

In S403, the processor 200 may obtain a classification object based on deep learning.

The processor 200 may use a network for image learning to learn a grid map that is image data. For example, the processor 200 may use a single shot multibox detector (SSD) model or a you only look once (YOLO) model.

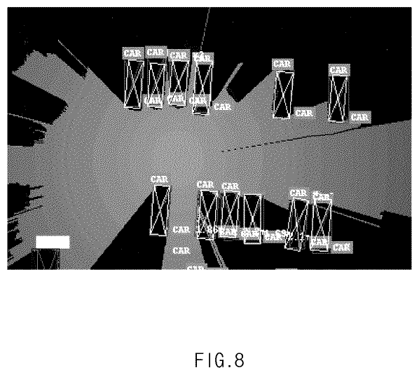

FIG. 8 is a drawing illustrating an example of classification objects obtained using an SSD model.

Referring to FIG. 8, a processor 200 may obtain a classification object, such as CAR, using the SSD model. To this end, the SSD model may generate a different default box for each cell in a plurality of specific maps and may recognize an object using the default box.

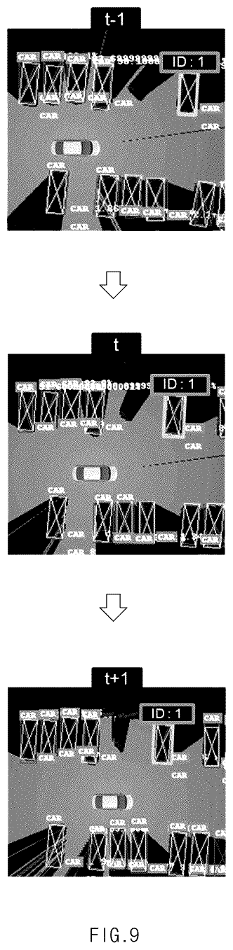

In S404, the processor 200 may track a classification object. A description is given of an example of tracking the classification object with reference to FIG. 9.

FIG. 9 is a drawing for describing a method for tracking a classification object.

Referring to FIG. 9, a processor 200 may track classification objects based on speed information of respective grids in a process of generating a dynamic grid map.

Each of occupancy grids may include a speed component Vx in the direction of an x-axis and a speed component Vy in the direction of a y-axis. Based on this information, the processor 200 may determine movement directions and speeds of classification objects and may predict movement of the classification objects. Furthermore, the processor 200 may track a classification object based on a position of the predicted classification object and a position of the actually detected classification object.

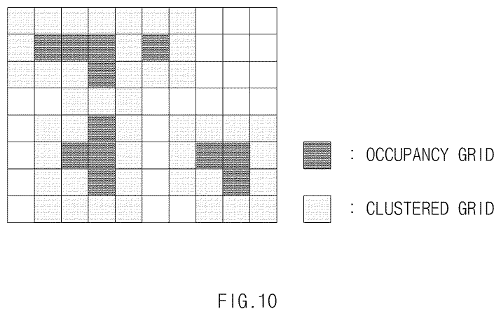

In S405, the processor 200 may obtain a grid object based on grid information. A description is given of a method for obtaining the grid object with reference to FIG. 10.

FIG. 10 is a drawing for describing a method for obtaining a grid object.

Referring to FIG. 10, a processor 200 may detect an occupancy grid based on an occupancy probability of grids. A method for detecting the occupancy grid may use the embodiment shown in FIG. 5.

The processor 200 may detect surrounding grids adjacent to the occupancy grid. The processor 200 may detect a grid object including the occupancy grid and the surrounding grid. The grid objects touching each other may be estimated as the same object.

Furthermore, the processor 200 may divide grids with different speeds among grids in one cluster state, which touch each other, into different grid objects. In other words, the processor 200 may determine a speed of each grid included in the grid object and may divide grids with different speeds into different grid objects.

In S406, the processor 200 may track a grid object.

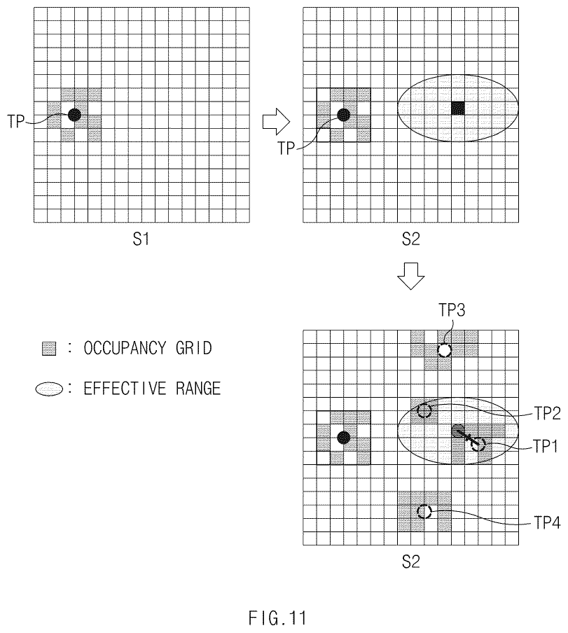

FIG. 11 is a drawing for describing a method for tracking a grid object.

A description is given of the method for tracking the grid object with reference to FIG. 11.

In S1, a processor 200 may identify an ID of a grid object including an occupancy grid in an (n−1) th frame (where n is a natural number). The processor 200 may assign a new ID to a new grid object. FIG. 11 illustrates a grid object to which an ID is assigned as 1. The processor 200 may determine a tracking point (TP) in a grid object area. The TP may be selected among occupancy grids and may be a point corresponding to a vertex of occupancy grids.

In S2, the processor 200 may determine a prediction point of the TP. The processor 200 may determine the prediction point based on speed information of the occupancy grid. Furthermore, the processor 200 may determine an effective range around the prediction point. The effective range may be a circle around the prediction point. The effective range may be an oval in which a movement direction of the TP is a long axis.

In S3, the processor 200 may obtain TPs TP1, TP2, TP3, and TP4 of grid objects in an nth frame. The processor 200 may extract TPs TP1 and TP2, which belong within the effective range, among the plurality of TPs TP1, TP2, TP3, and TP4. The processor 200 may determine the TP TP1 closest to the prediction point among TPs that belong within the effective range as a TP of the grid object to which the ID is assigned as 1. In other words, the processor 200 may determine that the TP obtained in the (n−1)th frame moves to the TP TP1 obtained in the nth frame. Thus, the processor 200 may maintain the ID of the grid object corresponding to the TP TP1 as 1.

In S407, the processor 200 may fuse the tracked results.

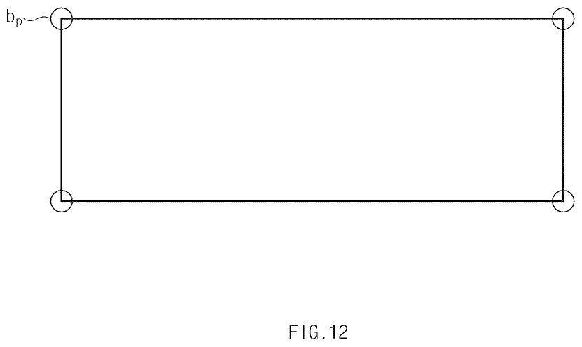

A method for fusing the tracked results is described with reference to FIGS. 12-14.

FIG. 12 is a drawing illustrating a bounding box area.

Referring to FIG. 12, a processor 200 may obtain vertices bₚ of a bounding box Bbox. Each of the vertices bₚ of the bounding box Bbox may be one grid.

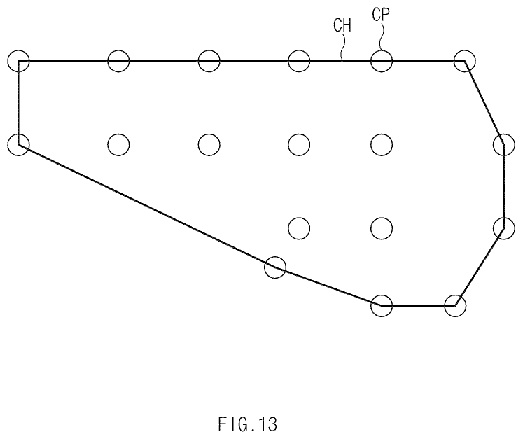

FIG. 13 is a drawing illustrating a cluster area.

Referring to FIG. 13, a cluster area may refer to an internal area of a convex hull CH surrounding a grid object. Cluster points CP constituting the cluster area may be a grid unit. In other words, the one cluster point CP may be one grid.

The convex hull CH may be obtained using a convex hull algorithm.

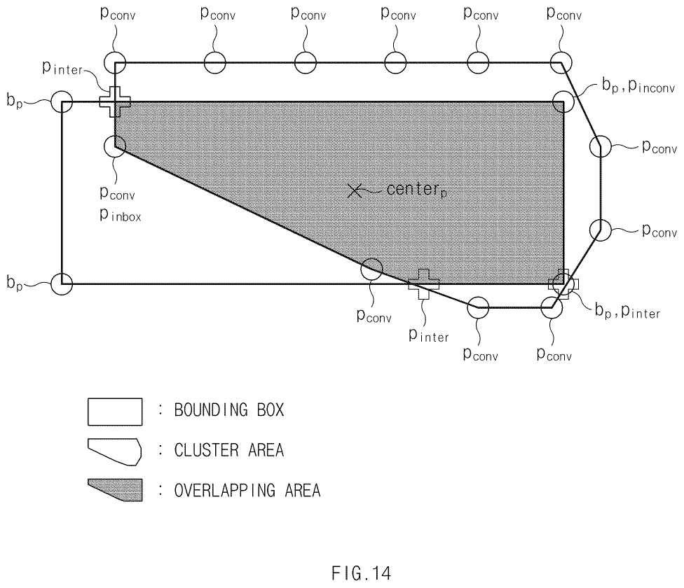

FIG. 14 is a drawing for describing a method for determining an intersection area between a bounding box area and a cluster area. Respective points shown in FIG. 14 may be grids.

Referring to FIG. 14, a processor 200 may obtain boundary points Pconv that belong to a convex hull CH of a cluster area. The boundary points Pconv may be grids located on the convex hull CH.

The processor 200 may determine an area of the cluster area. The processor 200 may determine the area of the cluster area based on the number of grids including the boundary points Pconv.

The processor 200 may obtain an intersection point Pinter of a bounding box Bbox and the convex hull CH.

The processor 200 may obtain one or more first internal points Pinbox located in the bounding box Bbox among the boundary points Pconv.

The processor 200 may obtain one or more second internal points Pinconv located in a convex hull among grids corresponding to vertices bₚ of the bounding box Bbox.

The processor 200 may determine an area connecting the intersection point Pinter, the first internal point Pinbox, and the second internal point Pinconv as an overlapping area.

The processor 200 may determine that a classification object and a grid object as the same object based on a size of the overlapping area compared to the cluster area being greater than or equal to a threshold. In other words, when a condition represented in Equation 1 below is established, the processor 200 may determine that the classification object and the occupancy object are the same object.

$$\frac{Intersection Area}{Cluster Area} \geq Threshold \qquad [ Equation 1 ]$$

Furthermore, the processor 200 may obtain a center center_p of the grid object and may track an object using the center center_p of the grid object.

In S408, the processor 200 may control a driving controller 400 based on the tracked result.

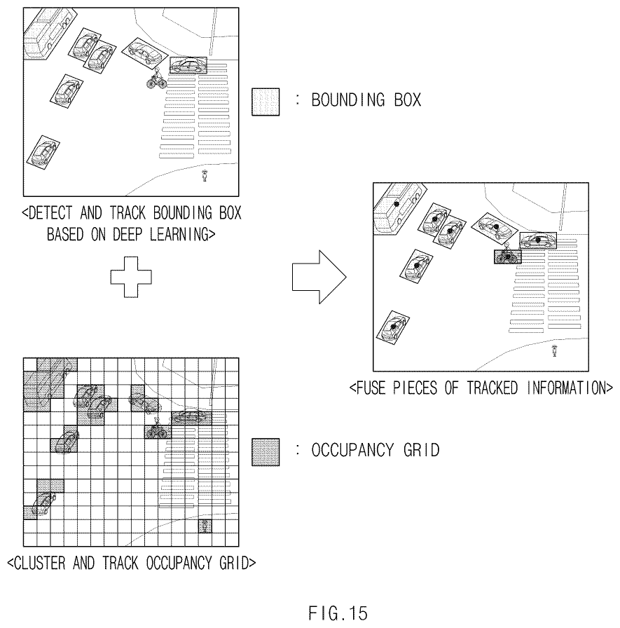

FIG. 15 is a drawing for describing an example of an object tracking method according to an embodiment of the present disclosure.

Referring to FIG. 15, a processor 200 may deep-learn a grid map in the form of a top-view image, which is generated based on surrounding information, to obtain a bounding box. Each of the bounding boxes may indicate a classification object. The processor 200 may track bounding boxes. According to an embodiment of the present disclosure, the processor 200 may learn a dynamic grid map in the form of an image to predict movement positions of objects detected as bounding boxes using speed information of the dynamic grid map and may compare the predicted position with a measured position to more accurately perform object tracking.

The processor 200 may extract an occupancy grid from the grid map and may cluster the occupancy grid to obtain a grid object. Furthermore, the processor 200 may track grid objects. According to an embodiment of the present disclosure, the processor 200 may predict positions of the grid objects, based on speed information included in pieces of grid information of the grid objects. The processor 200 may allow the predicted grid object and the measured grid object to be identical to each other, thus more accurately performing object tracking.

The processor 200 may fuse pieces of tracking information of classification objects and grid objects, thus performing more accurate object recognition.

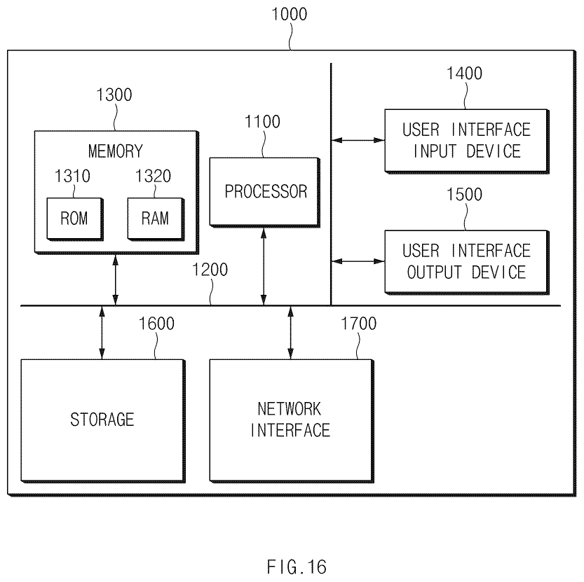

FIG. 16 illustrates a computing system according to an embodiment of the present disclosure.

Referring to FIG. 16, a computing system 1000 may include at least one processor 1100, a memory 1300, a user interface input device 1400, a user interface output device 1500, a storage 1600, and a network interface 1700, that are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read-only memory (ROM) 1310 and a random-access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a RAM, a flash memory, a ROM, an electrically programmable ROM (EPROM), an electrically erasable programmable ROM (EEPROM), a register, a hard disk, a removable disk, and a compact disk ROM (CD-ROM).

The storage medium may be coupled to the processor 1100. The processor 1100 may read out information from the storage medium and may write information in the storage medium. Alternatively, the storage medium may be integrated with the processor 1100. The processor and the storage medium may reside in an application-specific integrated circuit (ASIC). The ASIC may reside within a user terminal. In another case, the processor and the storage medium may reside in the user terminal as separate components.

According to an embodiment of the present disclosure, the object tracking apparatus may detect a classification object based on deep learning and may recognize an object based on a grid map, thus enhancing recognition performance more than when proceeding with object recognition based on only deep learning.

Furthermore, according to an embodiment of the present disclosure, the object tracking apparatus may determine a class and a shape of an object based on deep learning, thus overcoming difficulties in identifying a shape and a class of the object in an object recognition process based on the grid map.

Furthermore, according to an embodiment of the present disclosure, the object tracking apparatus may fuse a deep learning-based classification object and a grid object of the grid map to track an object, thus more accurately tracking the same object in consecutive frames.

In addition, various effects ascertained directly or indirectly through the present disclosure may be provided.

Hereinabove, although the present disclosure has been described with reference to embodiments and the accompanying drawings, the present disclosure is not limited thereto. The embodiments may be variously modified and altered by those of ordinary skill in the art to which the present disclosure pertains without departing from the spirit and scope of the present disclosure claimed in the following claims.

Therefore, embodiments of the present disclosure are not intended to limit the technical spirit of the present disclosure but are provided only for the illustrative purpose. The scope of the present disclosure should be construed based on the accompanying claims, and all the technical ideas within the scope equivalent to the claims should be included in the scope of the present disclosure.

What is claimed is:

1. An object tracking apparatus, comprising:
a sensor device configured to obtain surrounding information of a vehicle; and
a processor configured to track an object outside the vehicle, based on the surrounding information obtained by the sensor device,
wherein the processor is configured to
generate a grid map based on the surrounding information,
obtain a classification object based on a deep-learning of the grid map,
detect an occupancy grid from the grid map,
obtain a grid object based on clustering the occupancy grid, and
track the object based on fusing the classification object and the grid object.

2. The object tracking apparatus of claim 1, wherein the processor is configured to generate the grid map in the form of a top-view image.

3. The object tracking apparatus of claim 1, wherein the processor is configured to set a region of interest for limiting an object tracking region on the grid map.

4. The object tracking apparatus of claim 1, wherein the processor is configured to:
extract the occupancy grid based on an occupancy probability that the object will be present on each grid of the grid map;
extract one or more surrounding grids adjacent to the occupancy grid; and
obtain the grid object including the occupancy grid and the surrounding grids.

5. The object tracking apparatus of claim 4, wherein the processor is configured to divide the grid object into two or more different grid objects based on a speed of each grid that belongs to the grid object.

6. The object tracking apparatus of claim 1, wherein the processor is configured to:
determine a tracking point in the grid object in a first frame;
set an effective range around a prediction point of the tracking point in a moving state; and
determine whether the tracking point measured in a second frame obtained based on a determination that the first frame is located within the effective range and proceeds with tracking the grid object.

7. The object tracking apparatus of claim 1, wherein the processor is configured to obtain a bounding box surrounding the classification object, a class matched with the bounding box, and speed information of the classification object.

8. The object tracking apparatus of claim 7, wherein the processor is configured to:
determine a cluster area occupied by the grid object;
determine an overlapping area between an area of the bounding box and the cluster area; and
determine that the classification object and the grid object are the same object based on a size of the overlapping area compared to the cluster area is greater than or equal to a predetermined threshold.

9. The object tracking apparatus of claim 8, wherein the processor is configured to:
obtain a convex hull surrounding the grid object using a convex hull algorithm; and
determine an internal area of the convex hull as the cluster area.

10. The object tracking apparatus of claim 9, wherein the processor is configured to:
obtain one or more intersection points in which the bounding box and the convex hull intersect each other;
obtain one or more first internal points located in the bounding box among boundary points included in the convex hull;
obtains one or more second internal points located in the convex hull among grids corresponding to vertices of the bounding box; and
determine an area connecting the intersection point, the first intersection points, and the second intersection points as the overlapping area.

11. An object tracking method, comprising:
generating, by a processor, a grid map based on surrounding information outside a vehicle;
deep-learning, by the processor, the grid map to obtain a classification object;
detecting, by the processor, an occupancy grid from the grid map and obtaining a grid object based on clustering the occupancy grid; and
tracking an object, by the processor, based on a fusing the classification object with the grid object.

12. The object tracking method of claim 11, wherein the generating of the grid map includes:
generating the grid map in the form of a top-view image.

13. The object tracking method of claim 11, further comprising:
setting a region of interest for limiting an object tracking region.

14. The object tracking method of claim 11, wherein obtaining the grid object includes:
extracting an occupancy grid based on an occupancy probability that the object will be present on each grid of the grid map;
extracting one or more surrounding grids adjacent to the occupancy grid; and
obtaining the grid object including the occupancy grid and the surrounding grids.

15. The object tracking method of claim 14, wherein obtaining the grid object further includes:
dividing the grid object into two or more different grid objects based on a speed of each grid included in the grid object.

16. The object tracking method of claim 11, wherein obtaining the grid object includes:
determining a tracking point in the grid object in a first frame;
setting an effective range around a prediction point of the tracking point in a moving state; and
determining whether the tracking point measured in a second frame obtained after the first frame is located within the effective range and proceeding with tracking the grid object.

17. The object tracking method of claim 11, wherein obtaining the classification object includes:
obtaining a bounding box surrounding the classification object;
obtaining a class matched with the bounding box; and
obtaining speed information of the classification object.

18. The object tracking method of claim 17, wherein fusing the classification object with the grid object to track the object includes:
determining a cluster area occupied by the grid object;
determining an overlapping area between an area of the bounding box and the cluster area; and
determining that the classification object and the grid object are the same object, based on a size of the overlapping area compared to the cluster area is greater than or equal to a predetermined threshold.

19. The object tracking method of claim 18, wherein determining the cluster area includes:
obtaining a convex hull surrounding the grid object using a convex hull algorithm; and
determining an internal area of the convex hull as the cluster area.

20. The object tracking method of claim 19, wherein fusing the classification object with the grid object to track the object includes:
obtaining one or more intersection points in which the bounding box and the convex hull intersect each other;
obtaining one or more first internal points located in the bounding box among boundary points included in the convex hull;
obtaining one or more second internal points located in the convex hull among grids corresponding to vertices of the bounding box; and
determining an area connecting the intersection point, the first intersection points, and the second intersection points as the overlapping area.
